(19) United States
(12) Patent Application Publication
(10) Pub. No.: US 2005/0000475 A1
(43) Pub. Date: Jan. 6, 2005

(54) Hydraulic control system for a variable compression ratio internal combustion engine

(76) Inventor: Joseph Edward Casterline, Tucson, AZ (US)

Correspondence Address: JOSEPH E. CASTERLINE, 4839 E. RAIL - N ROAD, TUCSON, AZ, 85739, US

(21) Appl. No.: 10/612,526

(22) Filed: Jul. 2, 2003

(51) Int. Cl. F02B 75/04

(52) U.S. Cl. 123/48 B

(57) ABSTRACT

A moveable crankshaft assembly that is positioned by an hydraulic positioning device hydraulically connected to a constant pressure hydraulic reservoir. The hydraulic connections between the reservoir and the positioning device are equipped with pressure relief valves, or equivalent substitutes, connected in parallel to pass fluid in either direction to maintain the same pressure in the hydraulic positioning device as in the reservoir. A coupling is installed between the crankshaft and the power train that is capable of accommodating movement.

This patent application relates to Provisional Patent Application Confirmation No.9946, Application No. 60/393,786, Filing Date Jul. 8, 2002.

### TECHNICAL FIELD

The present invention relates to a control system to vary the compression ratio of an internal combustion engine.

### BACKGROUND

A major factor affecting the efficiency of an internal combustion engine is the compression ratio. In general, the higher the compression ratio, the more efficient the engine. Unfortunately, there are a number of considerations that impose limits on the maximum value that can be used. Generally, the compression ratio used is based on the one that provides satisfactory anti-knock operation over the anticipated useful power range, with particular attention to full power operation. At full power, the fuel and air mixture enters the cylinder at essentially ambient conditions. The compression raises the pressure and the temperature to a level that will not cause pre-ignition detonation and, after ignition, produces the desired peak pressure in the cylinder. When operating at less than full power, the adiabatic expansion, due to throttling, causes the fuel and air mixture entering the cylinder to be at less than ambient pressure and temperature. These conditions present an opportunity to use a higher compression ratio; in fact, it is possible to produce conditions, prior to and after ignition, similar to those obtained at full power. The desired reduction in power is realized by expanding a smaller volume of gas. The increased compression ratio would increase efficiency. Since most automobiles operate at less than full power most of the time, the ability to vary the compression ratio appropriately would improve efficiency for most operating conditions.

A large number of patents have been issued to vary the compression ratio. These have included various ways to change the length of the connecting rods or to utilize eccentric members on the crankshaft or connecting rods which, when rotated, change the compression ratio. None of these patents has resulted in a commercially viable product, largely due to complexity and uncertainty about their efficacy.

### SUMMARY OF THE INVENTION

The control system covered by this patent uses the peak pressure in the cylinder after ignition as determined by the peak piston force on the crankshaft as a control objective. The hydraulic pressure in the constant pressure reservoir is maintained at a value that provides the hydraulic positioning device with a pressure that balances the maximum force after ignition exerted on the crankshaft by the pistons when operating at full power and design compression ratio. When operating at less than full power, the force on the crankshaft will be reduced and fluid will be transferred from the constant pressure reservoir to the hydraulic positioning device, moving the assembly closer to the engine block. This will increase the compression ratio until the maximum force exerted on the crankshaft after ignition is the same as that produced by the engine when operated at full power and design compression ratio. For specific engines, at very low power levels, mechanical constraints will prevent realization of the full benefit over a small portion of the usable power range. When power is increased from a lower level to a higher level, the force exerted on the crankshaft by the pistons will increase and fluid will flow from the positioning device to the constant pressure reservoir, moving the crankshaft away from the engine block, thereby lowering the compression ratio to the one that produces the desired maximum pressure in the cylinders after ignition.

When power is increased, the pressure relief valve that permits hydraulic fluid to flow from the hydraulic positioning device to the constant pressure reservoir will open, moving the crankshaft assembly away from the engine block (reducing compression ratio). This valve is large to permit rapid fluid flow, preventing overpressure. When power is decreased, the pressure relief valve that permits hydraulic fluid to flow from the constant pressure reservoir to the hydraulic positioning device (increasing compression ratio) is small and orifaced or equipped with a short time delay to prevent undesirable movement between power strokes.

### BRIEF DESCRIPTION OF THE DRAWINGS

FIG. 1 is a schematic arrangement of engine block, hinged crankshaft assembly and hydraulic positioning device.

FIG. 2 is a schematic arrangement of constant pressure hydraulic fluid reservoir with tubing and pressure relief valves.

FIG. 3 is an operating cycle at full power and design compression ratio of 7:1.

FIG. 4 is an operating cycle at 34% power and design compression ratio of 7:1.

FIG. 5 is an operating cycle at 34% power and compression ratio of 19:1.

FIG. 6 is a coupling between the moveable crankshaft assembly and the drive train.

### DESCRIPTION OF THE PREFFERED EMBODIMENTS

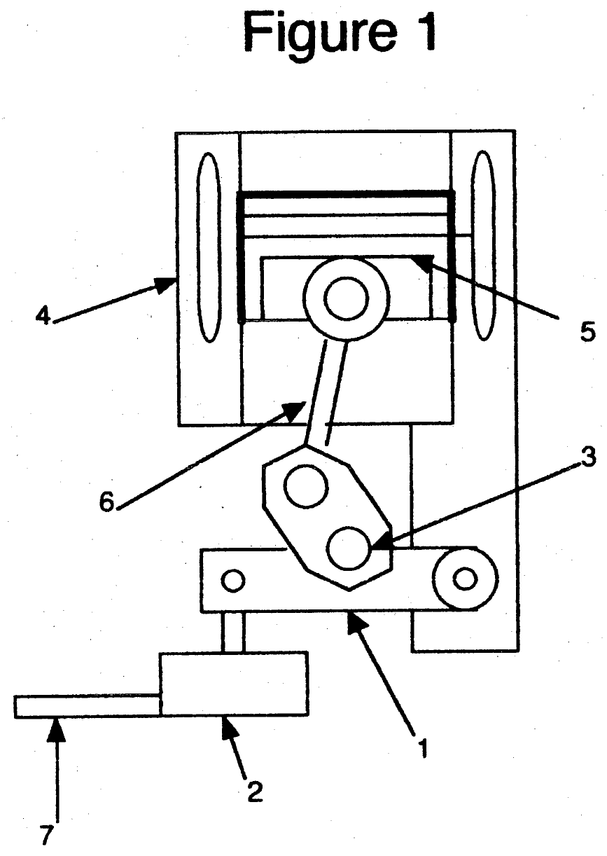

Referring to FIG. 1, an engine block 4, pistons 5, connecting rod 6, crankshaft 3, hinged moveable crankshaft assembly 1, hydraulic positioning device 2 and hydraulic tubing 7 leading to constant pressure hydraulic reservoir.

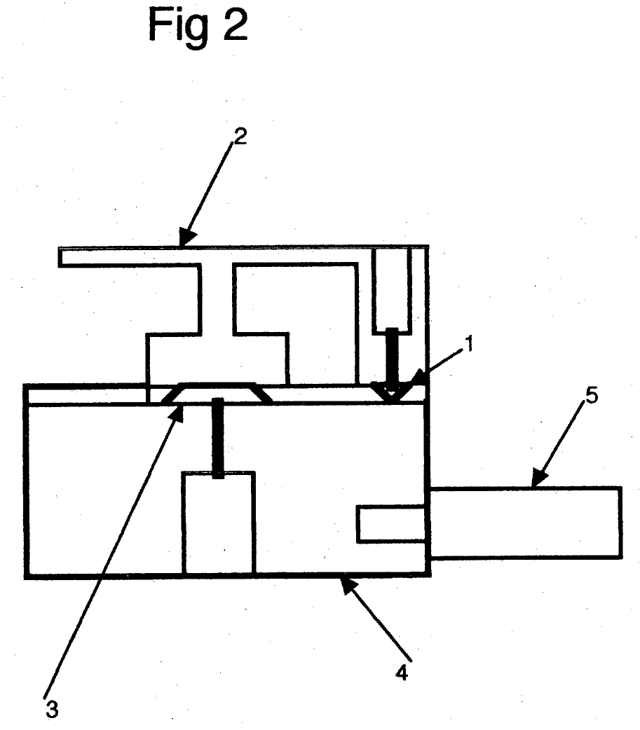

Referring to FIG. 2, the hydraulic fluid constant pressure reservoir 4, spring-loaded piston to maintain desired hydraulic pressure 5, pressure relief valve 3 allows fluid to pass from thehydraulic positioning device to the hydraulic fluid reservoir, pressure relief 1 valve 1 allows fluid to flow from the reservoir to the hydraulic positioning device. Tubing 2 connects the hydraulic reservoir with the hydraulic positioning device.

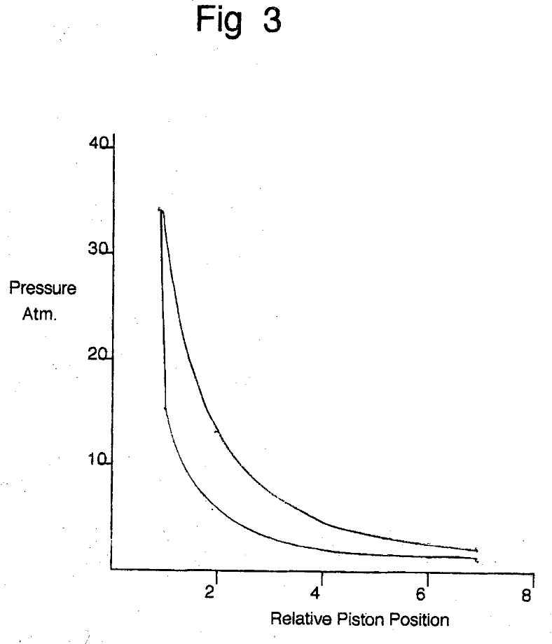

Referring to FIG. 3, a pressure versus volume plot for a cycle at full power and design compression ratio of 7:1.

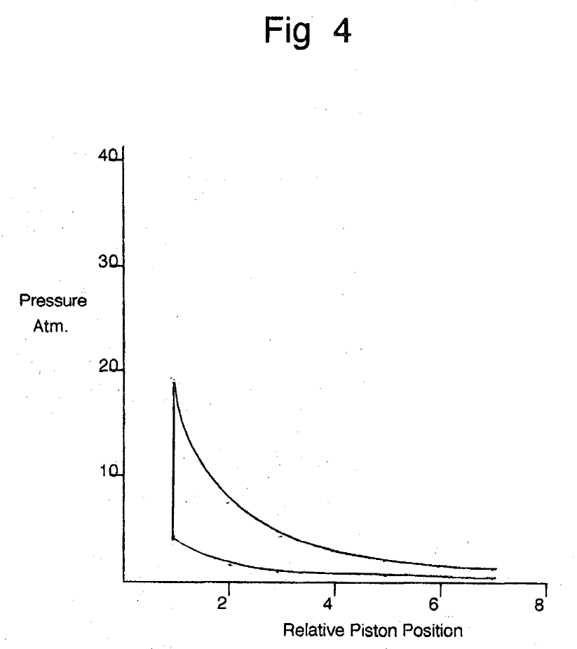

Referring to FIG. 4, a pressure versus volume plot for a cycle at 34% power and design compression ratio of 7:1.

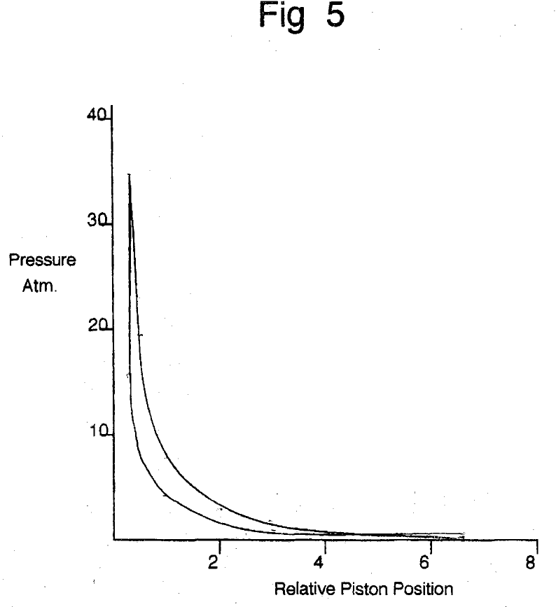

Referring to FIG. 5, a pressure versus volume plot for a cycle at 34% power and compression ratio of 19:1.

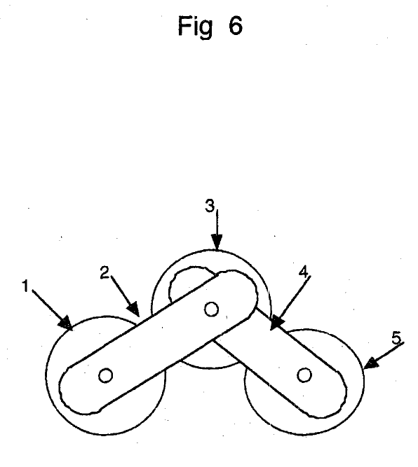

Referring to FIG. 6, a geared coupling between movable crankshaft and drive train. Gear attached to moveable crankshaft 1, idler gear 3, gear attached to drive train 5. Bracket 2 connects gears 1 and 3 bracket 4 connects gears 3 and 5.

1. A control system which varies the compression ratio of an internal combustion engine, comprising:
a. A moveable crankshaft assembly which is equipped with maximum and minimum limiting stops.
b. An hydraulic device, such as an hydraulic cylinder, which positions the moveable crankshaft assembly.
c. A constant pressure reservoir that is maintained at constant pressure within predetermined limits.
d. Hydraulic connections that are between the moveable crankshaft hydraulic positioning device and the constant pressure hydraulic reservoir.
c. Pressure relief valves, or equivalent devices, that permit passage of the hydraulic fluid in either direction between the hydraulic positioning device and the constant pressure reservoir.
f. A coupling between the moveable crankshaft assembly and the power train capable of accommodating the movement and transferring the rotational movement of the crankshaft to the power train.

2. A moveable crankshaft assembly attached to the engine block on one side with hinges parallel to the axis of the engine and supported on the other side by the hydraulic positioning device which moves the hinged assembly to obtain the desired compression ratio.

3. Hydraulic connections between the hydraulic positioning device and the constant pressure reservoir consisting of appropriate tubing and pressure relief valves, or equivalent devices, installed in a manner to pass fluid in either direction between the hydraulic positioning device and the constant pressure reservoir to maintain the same pressure throughout the system. Pressure is maintained in the constant pressure reservoir by a spring-loaded piston.
